(19) United States
(12) Patent Application Publication
(10) Pub. No.: US 2026/0050798 A1
(43) Pub. Date: Feb. 19, 2026

(54) KERNEL TRANSFORM IN NEURAL NETWORK TOPOLOGY SELECTION

(71) Applicant: Arm Limited, Cambridge (GB)

(72) Inventors: Shuokai Pan, Alconbury Weald (GB); Chuteng Zhou, Somerville, MA (US); Durmus Alp Emre Acar, Saugus, MA (US)

(21) Appl. No.: 18/807,775

(22) Filed: Aug. 16, 2024

(51) Int. Cl. G06N 3/0985

(52) U.S. Cl. CPC G06N 3/0985

(57) ABSTRACT

A neural network topology is selected by generating a super-neural network embedding one or more of a plurality of candidate neural networks having different topologies, and generating at least one learnable transform comprising a plurality of trainable weights. At least one of the plurality of candidate neural networks is generated at least in part by applying the at least one learnable transform to the super-neural network. A candidate neural network is selected from among the plurality of candidate neural networks having different topologies for deployment based on performance metrics and topological constraints.

### FIELD

The field relates generally to neural network topology selection, and more specifically to using a kernel transform in neural network topology selection.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

Modern computerized devices such as smartphones perform many of the functions that were primarily performed by large desktop computers a generation ago, such as web browsing, text messaging, emailing, videoconferencing, and playing video games. Such devices increasingly employ advanced technologies such as artificial intelligence, three-dimensional rendered graphics, and the like. Apple Siri and Google Assistant are examples of voice assistants that employ artificial intelligence such as neural networks, pretrained generative transformers, and the like to enable natural language communication and provide answers to natural language questions. Three-dimensional graphics rendering pipelines also increasingly employ artificial intelligence such as neural networks to predict motion and lighting of objects, de-noise or otherwise filter rendered images, and to perform other such tasks. Augmented or virtual reality may also employ significant neural network processing to recognize objects, provide realistic rendering, and the like.

But, these artificial intelligence tools such as neural networks are often deployed on battery-powered devices with limited power and compute capacity, such as smart phones, tablet computers, or wearable electronics. Performance constraints, such as rendering image frames in real time or responding to inputs such as voice prompts or captured images with a reasonable latency are also important to delivering a quality user experience. Neural networks and other artificial intelligence tools that perform well on a large computer may therefore need to be scaled down to perform well under the processing capacity, electrical power, and working memory constraints of devices such as smart phones.

Determining how to scale down a neural network for use on a device with limited resources while preserving the neural network's performance is a complex task. Because the neural network is typically trained using methods such as backpropagation of error and gradient descent, the explicit contribution of each node or portion of the neural network can be hard to quantify or determine. Typical approaches include defining model accuracy constraints and acceptable latency and searching for topologies meeting both constraints using trial and error, but such approaches rely heavily upon chance to find an acceptable solution and are inefficient.

For reasons such as these, a need exists for improved selection of neural network architectures meeting performance and resource constraints.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a system diagram showing selectin and deployment of a neural network in a resource-constrained environment, consistent with an example embodiment.

FIG. 2 shows training a candidate neural network using a linear transform, consistent with an example embodiment.

FIG. 3 is a flow diagram of a method of applying genetic modifications to candidate neural networks, consistent with an example embodiment.

FIG. 4 shows pseudo code for a genetic neural architecture search algorithm, consistent with an example embodiment.

FIG. 5 is a chart showing performance of a linear transform-trained super neural network relative to a standard super neural network, consistent with an example embodiment.

FIG. 6 is a chart showing performance of zero-shot training a super neural network for sub-network selection relative to a human expert selected network, consistent with an example embodiment

FIG. 7 is a flow diagram of a method of using a learnable transform to train and select candidate neural sub-networks, consistent with an example embodiment.

FIG. 8 is a schematic diagram of a neural network, consistent with an example embodiment.

FIG. 9 shows a convolutional neural network, consistent with an example embodiment.

FIG. 10 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As neural networks are employed to perform increasingly complex tasks such as natural language processing, rendered image sequence processing, and content creation, the size and complexity of such neural networks continues to grow. Designing and selecting neural networks that run on computing devices having limited computational resources, limited power or battery life, or limited memory often involves a compromise between architectural constraints, such as the neural network size and latency, and performance constraints, such as accuracy in predicting a desired result. In one such example, real-time chatbot applications using large language models (or LLMs) may have strict tokens per second requirements for providing an acceptable user experience, but be constrained by the processor, memory, and battery power available on a smartphone hosting the chatbot.

Selection of neural network architectures providing acceptable accuracy while meeting computing environment constraints is not a trivial task, as it is difficult to understand or quantify the role that various nodes or segments of a neural network play in providing accurate predictions or outputs. Random selection or trial-and-error may therefore be employed to generate candidate neural network topologies, such that those random topologies providing the best mix of accuracy and latency or resource constraints is selected. Developers of applications such as these may desire improved methods of selecting a neural network topology when facing such constraints, such as to improve the performance of their software in constrained computing environments or to demonstrate better performance numbers for machine learning tasks on specific hardware such as a current-generation mobile processor.

Some examples described herein therefore address concerns such as these by providing improved methods of selecting a neural network architecture such as when computing resources are constrained. In one such example, a neural network topology is selected by generating a super-neural network embedding one or more of a plurality of candidate neural networks having different topologies. At least one learnable transform is generated comprising a plurality of trainable weights, with at least one of the plurality of candidate neural networks to be generated at least in part by applying the at least one learnable transform to the super-neural network. A candidate neural network is selected from among the plurality of candidate neural networks having different topologies, such as by selecting a candidate neural network having the best performance metrics while meeting computing resource or topology constraints.

In another example, a neural network topology is selected by selecting a plurality of candidate neural networks having different topologies from a super-neural network, and filtering the candidate neural networks based, at least in part, on one or more performance metrics from among the selected plurality of candidate neural networks. One or more genetic modifications are applied to the filtered candidate neural networks, and a genetic-modified candidate neural network is selected based, at least in part, on one or more performance metrics. In a further example, filtering the candidate neural networks based on performance metrics and applying genetic modifications to the filtered candidate neural networks are iterated repeatedly before selecting a genetic modified candidate neural network based on performance metrics as the selected neural network topology. Genetic modifications may include such modifications as cross-over between candidate neural networks and mutation of candidate neural networks.

Neural network topology selection methods such as these can improve the performance of neural networks having topology constraints, such as by identifying candidate neural networks meeting topology or latency constraints that have improved prediction accuracy or other performance metrics.

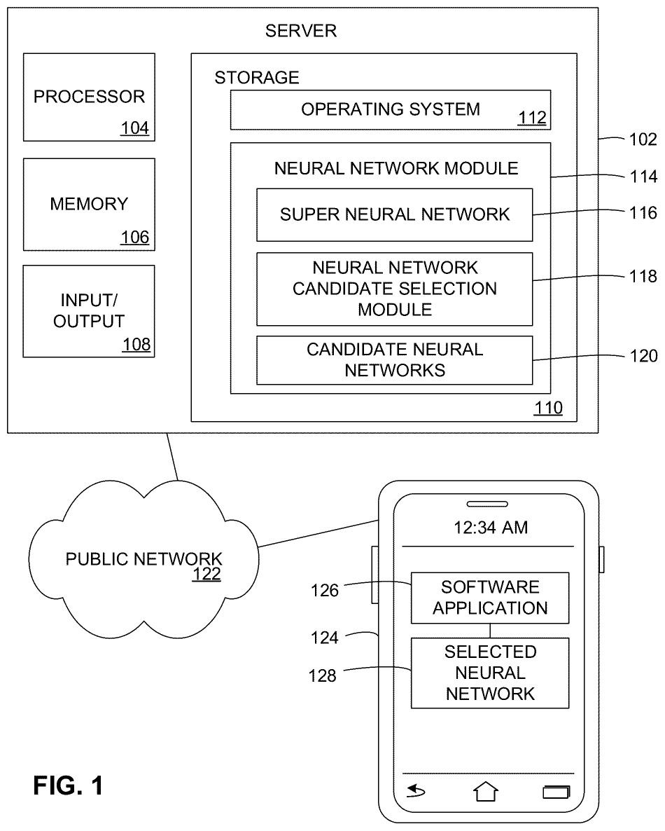

FIG. 1 is a system diagram showing selectin and deployment of a neural network in a resource-constrained environment, consistent with an example embodiment. Here, a server 102 includes a processor 104 operable to execute computer program instructions and a memory 106 operable to store information such as program instructions and other data while computerized server 102 is operating. The server may exchange electronic data, receive input from a user, and perform other such input/output operations with input/output 108. Storage 110 may store program instructions including an operating system 112 that provides an interface between software or programs available for execution and the hardware of the server, and that may manage other functions such as access to input/output devices. The storage 110 may also store program instructions and other data for a neural network module 114, including super neural network 116, a neural network candidate selection module 118, and candidate neural networks 120. In this example, the computerized device may also be coupled via a public network 122 to one or more user devices 124, such as smartphones, tablet computers, or other such computerized user devices.

The user device 124 in this example also comprises a software application 126 that is operable to execute computer program instructions, incorporating the selected neural network 128 that neural network candidate selection module selects from among candidate neural networks 120. In a more detailed example, user device 124 also comprises a memory that is operable to store information such as computer instructions and data being processed by executing programs, input/output such as a network connection to public network 122, and storage operable to store program instructions and data such as an operating system and a software application 126.

In operation, a super neural network 116 may be trained to perform a specific function, such as to predict language using a large language model (LLM), process or filter rendered image streams, or perform other such complex functions. The super neural network 116 may have a larger topology than is practical to run on a device having constrained resources such as a smartphone or tablet computer, such as by containing a greater number of nodes or other topological features or having a greater latency in generating a prediction than is acceptable on a mobile device. In further examples, the neural network module 114 may be operable to train the super neural network using methods such as application of a kernel transform that may be learned for each candidate neural network shape or topology, such as by backpropagation and gradient descent.

One or more candidate neural networks meeting latency, resource, or other such constraints are constructed and stored as candidate neural networks at 120, and in further examples may be derived from the super neural network 116 using methods such as random selection, truncation, genetic or evolutionary modification, or other such methods. Genetic modification in some examples may include creation of candidate neural networks by cross-over of existing candidate neural networks to generate new candidate neural networks, by mutation of existing candidate neural networks to generate new candidate neural networks, or by a combination of such methods or iterated or repeated use of such methods.

Candidate neural networks may be evaluated for their compliance with hardware constraints and latency as well as for performance such as accuracy in predicting a certain result via a candidate selection module 118. A elected candidate neural network meeting hardware or latency constraints and having best accuracy at predicting a desired result or other such metrics may be deployed via a public network 122 such as the Internet, a cellular network, an app store, or the like to one or more remote devices such as smart phone 124. The smart phone 124 in this example may receive the selected neural network such as embedded within a software application 126, and install and execute the software application 126 and associated selected neural network 128 to perform desired functions such as processing rendered image streams or interacting with a user via a large language model (LLM). The selected neural network in a more detailed example may be selected from the candidate neural networks 120 and modified using a learnable transform before deployment.

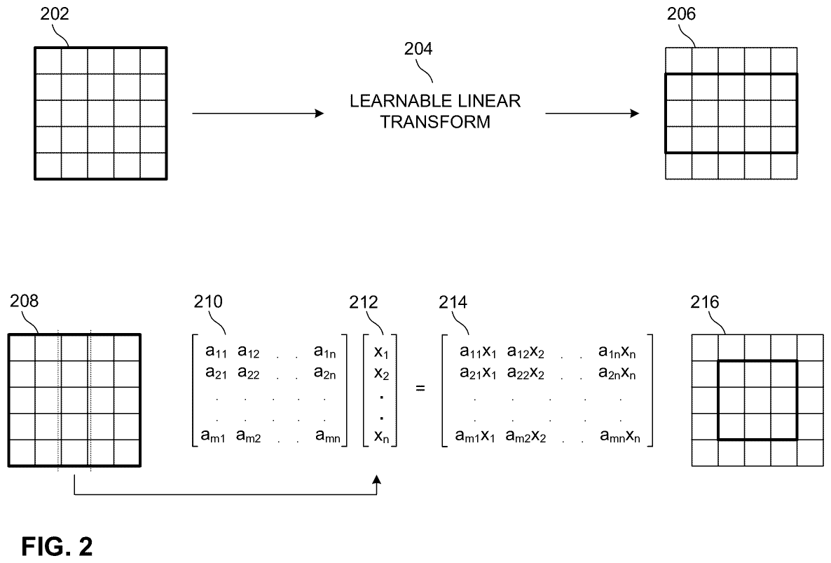

FIG. 2 shows training a candidate neural network using a linear transform, consistent with an example embodiment. Here, a super neural network is shown at 202 and 208, and different candidate neural networks derived from the super neural network are shown at 206 and 216. In a more detailed example, the super neural network embeds each of the candidate neural networks within it, and may correspond to the search space for candidate neural networks. Training the super neural network 202 may include training the super neural network using a variety of training samples, and in further examples may also use candidate neural networks embedded within the super neural network for some training samples where only the candidate neural network weights are updated during such training iterations. In a more detailed examples, a limited number of candidate neural networks are used for training, such as selecting a few random candidate networks for each training iteration and updating only the weights associated with the selected candidate networks in each iteration. Candidate sub-networks may be derived from the trained super neural network 202 as shown at 206 and 216, by simply selecting a subset of nodes and weights of the super neural network with no further training required, but the performance of such a candidate sub-network may be worse than if the candidate network were trained in isolation.

The example of FIG. 2 therefore introduces a learnable transform into training the candidate neural network, such as using learnable linear transform 204 to derive candidate neural network 206 from super neural network 202 and to train the super neural network. In a more detailed example, a super neural network such as is shown at 202 and 208 is trained along with a learnable linear transform shown at 204 and 212, using a different learnable linear transform for each different candidate neural network topology. The learnable linear transform may be adjusted during training using error backpropagation and gradient descent, much like the nodes making up the super neural network, and may be used after training to derive one or more candidate neural networks having a given topology from the super neural network. This allows the super neural network nodes to be better adapted to different candidate network topologies, yielding better weights for each candidate neural network.

The example of FIG. 2 shows application of this method to a convolutional neural network kernel shown at 202 and 208, using learnable linear transforms as shown at 204 and 212 to generate candidate neural networks having differing topologies as shown at 206 and 216.

Experimental application of the learnable transform concept has shown that different transforms for different two-dimensional kernel shapes can achieve significantly improved candidate network accuracy, such as where layers that have the same two-dimensional kernel shape but different input and output channel numbers or nodes may effectively use the same learnable transform. The number of extra learnable parameters is therefore reasonably small compared to the number of super neural network learnable weights, particularly in the context of applying a learnable transform to a convolutional neural network kernel.

In a more specific example, the super neural network shown at 208 is a 5×5 kernel of a convolutional neural network. A 3×5 candidate sub-network sliced from the super neural network is shown inside the thick black line at 206, and a 3×3 candidate sub-network sliced from the same super neural network having a different topology is shown inside the thick black line at 216. The convolutional neural network kernel shown at 208 as a super neural network and at 216 as a candidate neural sub-network are both configured to sweep left-to-right across an input tensor such as a two-dimensional image. Neural network connections from the middle column of the convolutional neural network kernel shown by dashed lines at 208 and at 212 may be affected by various learnable network weights in a 5×5 array of connections to a subsequent network layer. These network weights are modified by the kernel transform shown at 210 to generate the kernel transform-modified network weights as shown at 214. The network weights and the kernel transform may be trained using error backpropagation, gradient descent, and other such methods in various examples to generate candidate networks 216 having improved accuracy relative to training super neural networks and slicing candidate sub-networks without using a learnable transform.

In one such example, the accuracy or loss of candidate sub-networks using a learnable kernel transform in training the super neural network and in slicing the candidate sub-network from the super neural network is significantly improved (as much as 10%) relative to slicing a candidate sub-network from a super neural network trained without a learnable transform. The learnable kernel transform example studied was further significantly closer in performance to training each candidate sub-network from scratch than to slicing a candidate sub-network from a super neural network trained without a learnable transform, suggesting that training super neural networks and slicing candidate sub-networks using a learnable kernel transform is a reasonable alternative to the more computationally-expensive method of training each candidate sub-network from scratch.

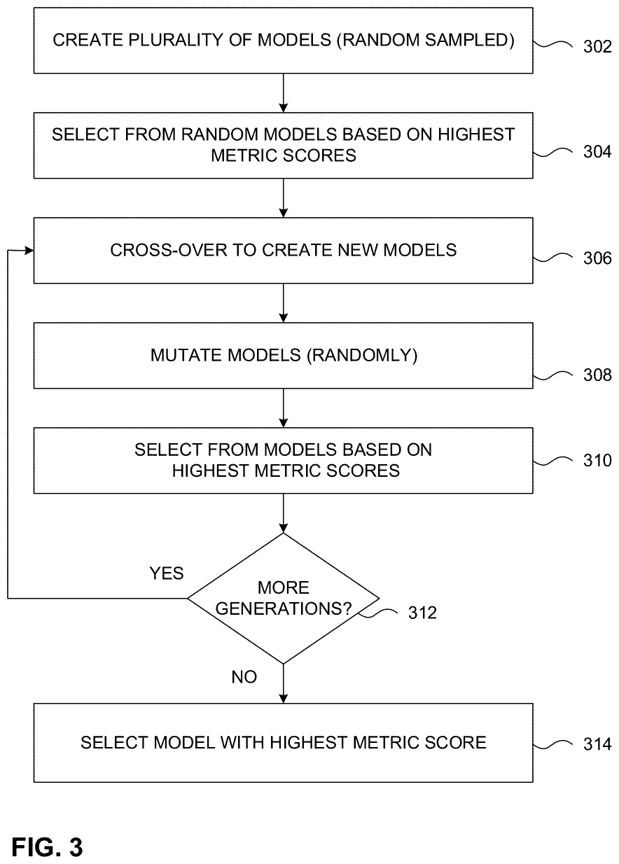

FIG. 3 is a flow diagram of a method of applying genetic modifications to candidate neural networks, consistent with an example embodiment. Genetic modifications in this example comprise modifications resembling genetic modifications that occur between generations in living organisms, such as cross-over, random mutation, and the like. By employing genetic modification and filtering the results to simulate a process such as natural selection, improvements in candidate neural networks or candidate neural network architectures can be realized.

A plurality of candidate neural network models may be created at 302, such as by random sampling of network nodes from a search space (such as a super neural network), selection of network topologies having produced favorable results in previous iterations, or other such methods. The sampled models or candidate neural networks in a further example may be selected to meet certain constraints, such as latency constraints, memory or processing power constraints, or other such constraints that may limit the size of the sampled models. The sampled models meeting the desired constraints may be tested at 304 for performance, such as accuracy in predicting a desired result, and may be filtered based on performance metrics such that only a certain percentage of the best-performing models are retained for subsequent steps.

At 306, the best-performing selected models may be processed using a cross-over algorithm to create various new models, such as by swapping or combining elements from different models to create new models. Models may also be mutated randomly at 308, such as by randomly changing the topology, weights, and/or other elements of models to create new mutated models. In some examples, some models may be processed using cross-over to create new models, some models may be mutated to create new models, and some models may be both processed using cross-over and mutation in various orders.

Original models in some examples are retained along with the genetically modified models. When models are again evaluated at 310 for performance metrics and filtered so that only the highest-performing percentage of models are retained, the genetically modified models may only be retained if they outperform other models such as the randomly sampled models. This process may mimic natural selection, in which genetic modifications are retained if they create a competitive advantage but are discarded if they result in a competitive disadvantage. Such advantageous genetic modifications to living organisms may occur and take hold over the course of many generations, and a decision may similarly be made at 312 as to whether more generations of genetic modification and filtering are desired for refining the sample or candidate neural network models. In some examples, the number of generations may be fixed, such as 50 or 100 generations, while in other examples new generations may be desired as long as improvement between generations continues to be observed such as during performance metric scoring at 310.

Once the desired number of generations of genetic modifications and filtering have taken place, the neural network model with the highest metric score is selected at 314. In some examples this may be a randomly selected model generated at 302, while in other examples this may be a model that has been genetically modified such as with one or more generations of cross-over, mutation, or the like.

The neural network models may in some examples be represented by one-hot encoding of network nodes in a neural network search space, such that each “one” represents a node selected for inclusion in a particular model instance. Such an encoding method may simplify representation and modification of the search space, the randomly selected neural network models, and genetic modification of models. Metrics may be in some examples one-shot or zero-shot, where one-shot means that weights are trained on a data sample to obtain a metric and zero shot means no training samples are employed to obtain a metric. Examples of zero shot metrics include the number of parameter, number of floating-point operations in a model, synaptic flow metrics, gradient norms, ZiCo score (inverse coefficient of variation on gradients), and other such metrics. Some metrics such as the number of parameters or operations can be calculated without processing data samples in the neural network model, while others such as gradient norms or ZiCo score are data-dependent and may involve testing with a small amount of sample data. Because zero shot metrics such as these have been shown to be positively correlated to the model accuracy after being fully trained, such metrics may be useful in selecting good candidate neural networks.

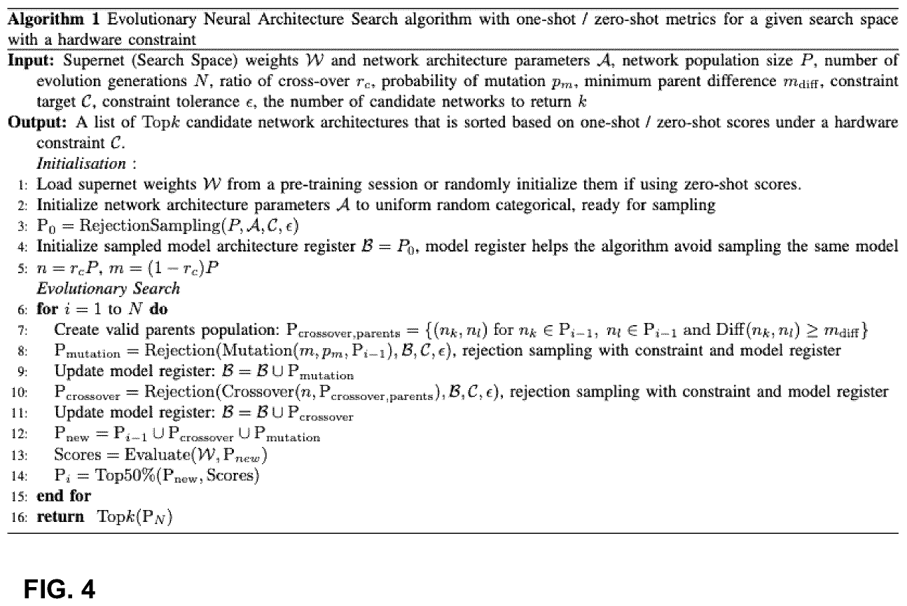

FIG. 4 shows pseudo code for a genetic neural architecture search algorithm, consistent with an example embodiment. The search algorithm shown here works within a given search space or super neural network having various parameters specified as Input, and an Output comprising top network architecture candidates meeting a hardware constraint and sorted based on one shot and/or zero shot metric scores. The algorithm may load a super neural network using pre-trained weights for one-shot metrics or random initialization of weights if using zero-shot metrics at step one, and samples a number of non-repeating model samples meeting hardware or other constraints at steps two to five. Steps six to fifteen describe how a model register is updated with samples that randomly undergo mutation and/or crossover, and such metrics are scored and the top 50% of resulting models are retained. This genetic modification process is repeated N times, after which the algorithm returns the top-performing models in ranked order.

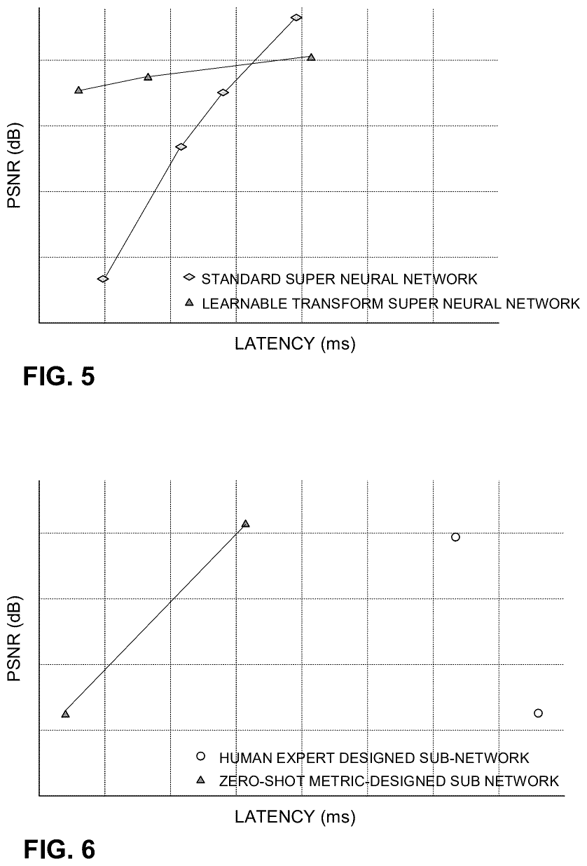

FIG. 5 is a chart showing performance of a linear transform-trained super neural network relative to a standard super neural network, consistent with an example embodiment. The chart here shows latency (increasing to the right) relative to peak signal-to-noise ratio or quality (increasing going up), such that the best performance is at the top left and the worst performance is at the bottom right of the chart. The gray diamonds show performance of a standard super neural network, sliced to achieve various degrees of latency to meet performance constraints. The gray triangles show performance of a learnable transform-trained super neural network, trained using learnable kernel transform coefficients. Both examples are trained to perform the same function using the same training data, relating to de-noising ray-traced images using a neural network in a graphics processor.

The respective data points and connecting lines in FIG. 5 illustrate that while performance of the standard super neural network (represented by gray diamonds) drops off relatively quickly as latency constraints are introduced (moving to the left), performance of a learnable kernel transform super neural network drops off much more slowly as latency constraints are introduced. This demonstrates the desirability of using a learnable transform in training a super neural network where latency, memory, processing power, or other such constraints are introduced in selecting a sub-network from a trained super neural network search space.

FIG. 6 is a chart showing performance of zero-shot training a super neural network for sub-network selection relative to a human expert selected network, consistent with an example embodiment. This chart shows latency (increasing to the right) relative to peak signal-to-noise ratio or quality (increasing going up), such that the best performance is again at the top left and the worst performance is at the bottom right. The gray diamonds show performance of a sub-network selected with zero-shot metrics relative to sub-networks manually designed by a human expert. Here, the sub-networks designed using human experts underperform the sub-networks selected using zero-shot metrics, showing that zero-shot metrics may be a more effective means of predicting or estimating performance of a sub-network than relying on human expertise. Further, because zero-shot metrics do not require training the neural network, the time to construct, select, and perform metrics on a candidate neural network are significantly reduced, such as from days to minutes.

Zero-shot metrics in some examples comprise metrics that can be obtained without training the network weights. Some examples may include the number of parameters of the neural network, the number of floating-point operations in the neural network, synaptic flow, gradient norms, ZiCo score (the inverse coefficient of variation of gradients), and the like. Some zero-shot metrics may not require processing any data using the neural network to determine, such as number of parameters or number of floating point operations, while other metrics may require processing a small amount of sample data such as gradient norms or ZiCo score. Because research such as that shown in FIG. 6 shows that many zero-shot metrics are positively correlated to model accuracy after the model is fully trained on a training data set, such metrics can be used to pick good sub-network candidate neural networks from a search space or super neural network.

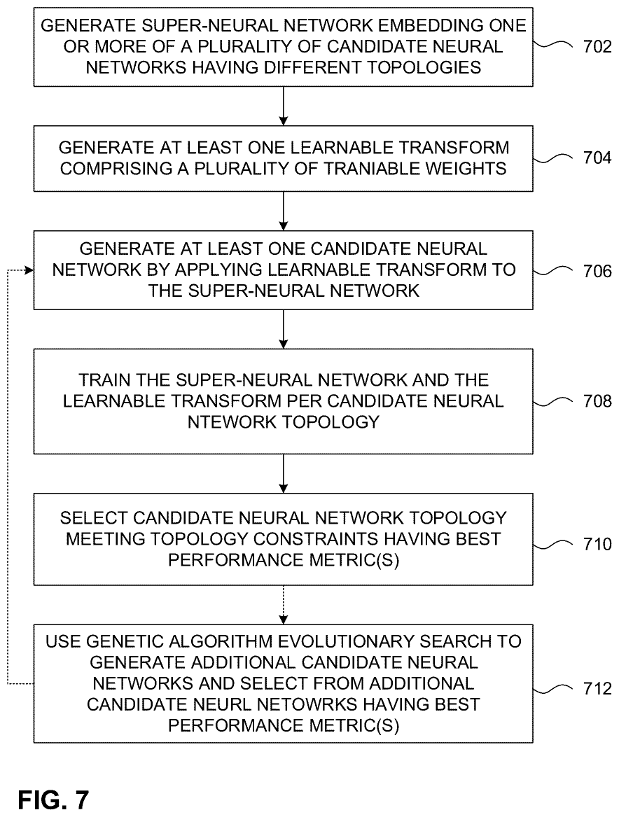

FIG. 7 is a flow diagram of a method of using a learnable transform to train and select candidate neural sub-networks, consistent with an example embodiment. At 702, a super neural network defining a candidate neural network search space is created, such that each of the candidate neural network topologies are contained or embedded in the search space or super neural network. At least one learnable transform is also created at 704, comprising a plurality of trainable weights. The learnable transform in some examples may be a kernel transform for a convolutional network. In some embodiments, the plurality of trainable weights in the learnable transform may be a one-dimensional, two-dimensional, or three-dimensional array of weights. In some examples, the super neural network and learnable weights may be trained at this point using methods such as backpropagation of prediction error and gradient descent, while other examples may use zero-shot metrics or other selection means that require little or no training or may be trained later, such as at 708.

At least one candidate neural network is generated at 706 by applying the learnable transform to a sliced or selected portion of the super neural network. In some examples, the super neural network may be trained using candidate neural network topologies such as by applying at least some training data to only a select portion of the super neural network corresponding to one or more of the candidate neural networks to train the neural network and the learnable transform. In such examples, only those weights corresponding to the selected candidate neural network and learnable transform may be changed as a result of training processes such as backpropagation of prediction error and gradient descent.

One or more candidate neural network topologies may be selected at 710, such as based on performance metrics. The performance metrics in some examples may be one-shot, requiring training data or another data record to be processed to generate a metric such as calculating error for a validation record of the training data set. In other examples, zero-shot metrics may be used, such as those described in conjunction with the examples of FIG. 6. Other examples may use larger volumes of training data, validation data, or other methods to measure performance. In some embodiments, the one or more selected candidate neural network topologies may be deployed, such as on a user device having limited power, computational capacity, memory, or other such constraints.

In some examples, additional methods may be employed to select and/or refine candidate neural networks, such as employing a genetic algorithm evolutionary search at 712 before selecting candidate neural networks having the best performance metrics. In a more detailed example, genetic modifications such as cross over and/or mutation may be performed before selecting the top 50% of candidate neural networks for retention. This process may iterate a number of times before a final candidate neural network is selected for deployment, as reflected by the dashed line returning the process to 706 for another iteration. The number of iterations may be predetermined, such as performing 50 iterations, or may be determined through other means such as iterating until the observed performance metrics do not improve for one or more generations.

Some machine learning model training may include training a neural network, such as by applying backpropagation of output errors using training data to weights applied to activation functions linking nodes in a neural network. In some examples, a neural network may comprise a graph comprising nodes, such as may model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In some implementations, transmission of an output signal from a node in a neural network may be inhibited if a strength of the output signal does not exceed a threshold value.

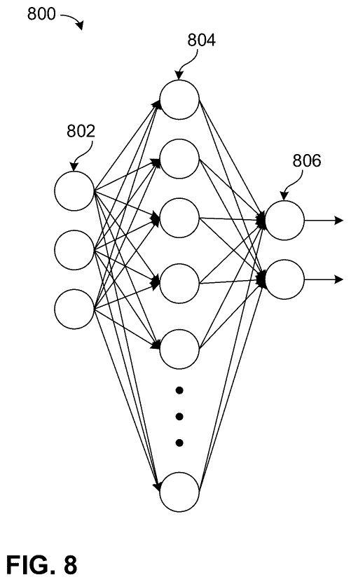

FIG. 8 is a schematic diagram of a neural network 800 formed in “layers” in which an initial layer is formed by nodes 802 and a final layer is formed by nodes 806. All or a portion of features of neural network 800 may be implemented various embodiments of systems described herein. Neural network 800 may include one or more intermediate layers, shown here by intermediate layer of nodes 804. Edges shown between nodes 802 and 804 illustrate signal flow from an initial layer to an intermediate layer. Likewise, edges shown between nodes 804 and 806 illustrate signal flow from an intermediate layer to a final layer. Although FIG. 8 shows each node in a layer connected with each node in a prior or subsequent layer to which the layer is connected, i.e., the nodes are fully connected, other neural networks will not be fully connected but will employ different node connection structures. While neural network 800 shows a single intermediate layer formed by nodes 804, other implementations of a neural network may include multiple intermediate layers formed between an initial layer and a final layer.

According to an embodiment, a node 802, 804 and/or 806 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

A neural network may be structured in layers, such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

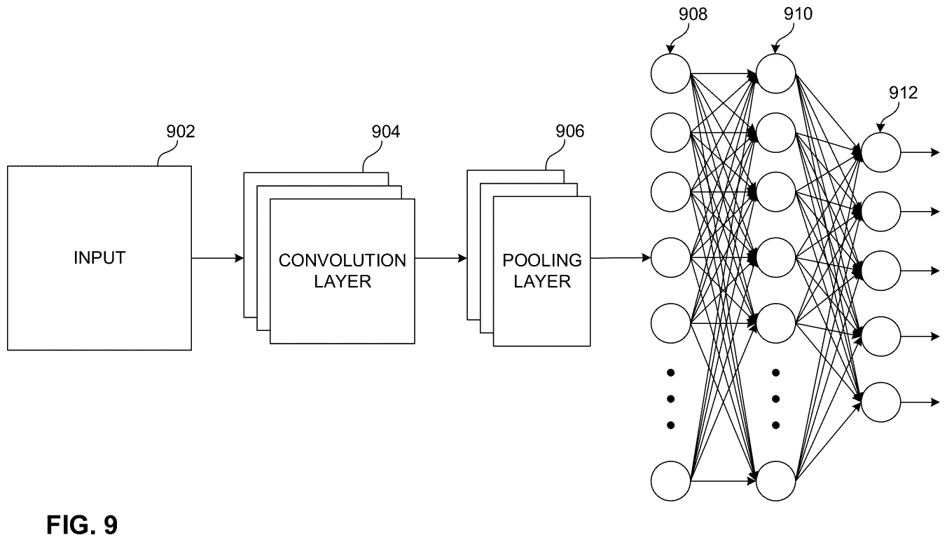

FIG. 9 shows a convolutional neural network, consistent with an example embodiment. A convolutional neural network is configured to recognize the importance of information in one input region relative to inputs in other input regions, such as the pixels around an object being filtered rather than pixels in a remote part of the image. Because spatial and temporal relatedness are built in to various convolutional neural network configurations, the convolutional neural network does not have to learn the importance of this relatedness as it would in a simple flattened backpropagation neural network and is more efficient.

In FIG. 9, the input 902 comprises an image which in this example is a 256×256 image in an RGB color space, having pixel locations arranged in a two-dimensional grid with three channels of color intensity or brightness (one channel each for red, green, and blue light). When performing image processing functions such as sharpening, blurring, de-noising, or the like, pixels immediately surrounding an image area being altered are most relevant to alteration of the image area, as are pixels in corresponding locations in each of the three color channels.

Convolution layer 904 comprises a kernel value derived from the image for the kernel region surrounding pixels in the original image, such as using a 3×3 kernel filter of nine pixels configured to include each original pixel as well as the eight pixels surrounding the original pixel. As the kernel filter is swept across the original image, an element-wise multiplication of the kernel filter and the image values is performed for each location, and a sum of each element in the product matrix is stored in the convolution layer 604. The kernel filter in some examples will weight each element equally, such as by having ones as multipliers in each element of the 3×3 kernel filter, but in other examples will weight elements differently by having different multipliers for different elements. Because the original image provided as an input at 902 is 256×256 and it is swept by a kernel filter of 3×3 that does not sweep outside the bounds of the original image, the output stored in convolution layer 904 is a matrix of size 254×254 in three channels. In another example, the original image is padded on all sides with a value such as zeros or with repeated border values to increase the input size to 258×258 before sweeping with the 3×3 kernel filter, resulting in an output stored in convolution layer 904 of 256×256 (the original input size). In some alternate examples, the three channels representing red, blue, and green colors are combined in a single channel, or in a fourth channel in addition to the three color channels.

Pooling layer 906 is configured to reduce the spatial size of the convolved features in convolution layer 904, which provides the benefit of reducing the computational power required to process the data. Pooling again involves sweeping the prior data structure with a kernel to produce a new data structure, such as sweeping the convolution layer matrix 904 with a 3×3 kernel. Common pooling algorithms include max pooling, in which the maximum value in the 3×3 kernel or window sweeping the convolution layer is recorded for each windowed location in the convolution layer, and average pooling, in which the average value in the 3×3 kernel sweeping the convolution layer is recorded for each swept location. Max pooling removes noise from data well, and is often preferred over average pooling in which dimensionality reduction is the primary effect.

The kernel in the pooling step in some examples is of different size than the kernel in the convolution layer step, and in another example strides or sweeps across the input data matrix by more than one element at a time. In one such example a 2×2 kernel is used in the pooling step, with a stride of two in each dimension, such that each data element in the convolution layer contributes to only one element in the pooling layer which is approximately one-fourth the size of the convolution layer. In further examples, one or more additional layers or variations on the convolution layer and/or the pooling layer are employed, and may be beneficial to reducing the computational power needed to recognize various elements or features in the input data 902. For example, the convolution and pooling layers may be repeated to further reduce the input data before further processing.

The pooling layer 906 is then flattened in flattened layer 908, for processing in a traditional feed-forward neural network comprising one or more intermediate layers as shown at 910. In a more detailed example, the feed-forward layers are fully connected, meaning each node in an intermediate layer is connected to each node in preceding and subsequent layers, and uses a nonlinear activation function such as the ReLU (rectified linear) or similar activation function. In other examples, the feed-forward layers are not fully connected, but use other node connection topologies.

The output 912 in the example of FIG. 9 comprises a soft-max activation function, in which the input image at 902 is classified as being one of five different possible outputs, such as an image of the letter A, B, C, D, or E. Practical convolutional neural networks often have significantly larger inputs and outputs than the example presented, here, and can perform more complex recognition or other filtering tasks at the expense of greater network complexity.

The convolutional neural network's input, output, and intermediate data sets are often referred to as “tensors”, which can have multiple dimensions or “ranks” depending on the data type, dimensionality, and number of channels in the data set. Vectors within a tensor represent related data elements, such as data set of 100 stocks having 365 daily closing prices in which 100 vectors of 365 elements each are stored in a 100×365 tensor denoted as (100,365). Complex data such as video may have many dimensions of related data, such as where a two-dimensional image of 1920×1080 plus color depth of 256 plus frame number in the video sequence of 10,000 comprise a four dimensional tensor (10000,1920,1080,256). Examples such as these illustrate the benefit of feature recognition and data reduction in a convolutional neural network before processing in a feed-forward neural network to make efficient use of processing power.

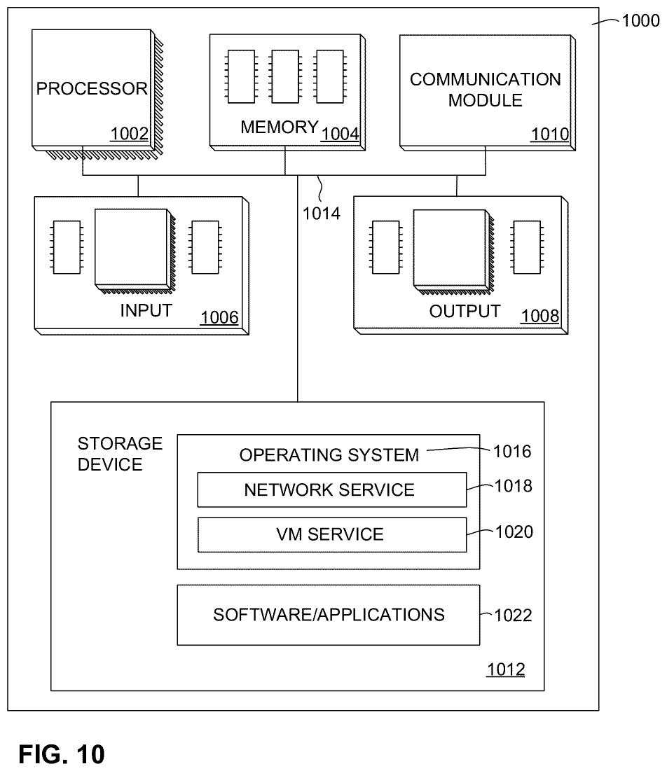

FIG. 10 shows a block diagram of a general-purpose computerized system, consistent with an example embodiment. FIG. 10 illustrates only one particular example of computing device 1000, and other computing devices 1000 may be used in other embodiments. Although computing device 1000 is shown as a standalone computing device, computing device 800 may be any component or system that includes one or more processors or another suitable computing environment for executing software instructions in other examples, and need not include all of the elements shown here.

As shown in the specific example of FIG. 10, computing device 1000 includes one or more processors 1002, memory 1004, one or more input devices 1006, one or more output devices 1008, one or more communication modules 1010, and one or more storage devices 1012. Computing device 1000, in one example, further includes an operating system 1016 executable by computing device 1000. The operating system includes in various examples services such as a network service 1018 and a virtual machine service 1020 such as a virtual server. One or more applications such as software application 1022 are also stored on storage device 1012, and are executable by computing device 1000.

Each of components 1002, 1004, 1006, 1008, 010, and 1012 may be interconnected (physically, communicatively, and/or operatively) for inter-component communications, such as via one or more communications channels 1014. In some examples, communication channels 1014 include a system bus, network connection, inter-processor communication network, or any other channel for communicating data. Applications such as application 1022 and operating system 1016 may also communicate information with one another as well as with other components in computing device 1000.

Processors 1002, in one example, are configured to implement functionality and/or process instructions for execution within computing device 1000. For example, processors 1002 may be capable of processing instructions stored in storage device 1012 or memory 1004. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 1012 may be configured to store information within computing device 1000 during operation. Storage device 1012, in some examples, is known as a computer-readable storage medium. In some examples, storage device 1012 comprises temporary memory, meaning that a primary purpose of storage device 1012 is not long-term storage. Storage device 1012 in some examples is a volatile memory, meaning that storage device 1012 does not maintain stored contents when computing device 1000 is turned off. In other examples, data is loaded from storage device 1012 into memory 1004 during operation. Examples of volatile memories include random access memories (RAM), dynamic random access memories (DRAM), static random access memories (SRAM), and other forms of volatile memories known in the art. In some examples, storage device 1012 is used to store program instructions for execution by processors 1002. Storage device 1012 and memory 1004, in various examples, are used by software or applications running on computing device 1000 such as application 1022 to temporarily store information during program execution.

Storage device 1012, in some examples, includes one or more computer-readable storage media that may be configured to store larger amounts of information than volatile memory. Storage device 1012 may further be configured for long-term storage of information. In some examples, storage devices 1012 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1000, in some examples, also includes one or more communication modules 1010. Computing device 1000 in one example uses communication module 1010 to communicate with external devices via one or more networks, such as one or more wireless networks. Communication module 1010 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 1000 uses communication module 810 to wirelessly communicate with an external device such as via public network 122 of FIG. 1.

Computing device 1000 also includes in one example one or more input devices 1006. Input device 1006, in some examples, is configured to receive input from a user through tactile, audio, or video input. Examples of input device 1006 include a touchscreen display, a mouse, a keyboard, a voice responsive system, video camera, microphone or any other type of device for detecting input from a user.

One or more output devices 808 may also be included in computing device 1000. Output device 1008, in some examples, is configured to provide output to a user using tactile, audio, or video stimuli. Output device 1008, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD or OLED), or any other type of device that can generate output to a user.

Computing device 1000 may include operating system 1016. Operating system 1016, in some examples, controls the operation of components of computing device 1000, and provides an interface from various applications such as application 1022 to components of computing device 800. For example, operating system 816, in one example, facilitates the communication of various applications such as federated learning module 822 with processors 802, communication unit 810, storage device 812, input device 806, and output device 808. Applications such as federated learning module 1022 may include program instructions and/or data that are executable by computing device 1000. These and other program instructions or modules may include instructions that cause computing device 1000 to perform one or more of the other operations and actions described in the examples presented herein.

Features of example computing devices such as those shown in FIGS. 1 and 10 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112(f) so that it is specifically intended that 35 USC § 112(f) not be implicated by use of the term “computing device,” “processor,” “processing unit,” “processing circuit” and/or similar terms; however, if it is determined, for some reason not immediately apparent, that the foregoing understanding cannot stand and that 35 USC § 112(f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Some embodiments may be described, at least in part, by the following numbered clauses or by any combination thereof:

Clause 1: A method of selecting a neural network topology, comprising: generating a super-neural network embedding a plurality of different candidate neural network topologies; generating at least one learnable transform comprising a plurality of trainable weights, each of the at least one learnable transforms associated with at least one of the plurality of different candidate neural network topologies; training the super-neural network and the at least one learnable transform by adjusting trainable weights of the learnable transform and the at least one of the plurality of candidate neural network topology embedded in the super-neural network using training data; generating a plurality of different candidate neural networks, each candidate neural network generated from a selected one of the plurality of different candidate neural network topologies, the trained super-neural network, and the at least one trained learnable transform associated with the selected one of the plurality of different candidate neural network topologies by applying the selected one of the plurality of different candidate neural network topologies to the super-neural network to generate a sliced neural network and applying the associated at least one learnable transform to the sliced neural network to generate the candidate neural network; and selecting a selected candidate neural network from among the plurality of different candidate neural networks.

Clause 2: The method of clause 1, wherein training the super-neural network and the at least one learnable transform comprises training different learnable transforms corresponding to different candidate neural network topologies.

Clause 3: The method of any of the aforementioned clauses, wherein training the learnable transform comprises using error backpropagation, gradient descent, or a combination thereof to adjust one or more trainable weights of the learnable transform.

Clause 4: The method of any of the aforementioned clauses, selecting a selected candidate neural network from among the plurality of different candidate neural networks comprises selecting a candidate neural network meeting at least one topology and/or latency constraint.

Clause 5: The method of any of the aforementioned clauses, the at least one learnable transform comprising multiple learnable transforms corresponding to multiple candidate neural network convolution kernel shapes.

Clause 6: The method of clause 5 or any of the aforementioned clauses, wherein a same learnable transform is used for a same candidate neural network convolution kernel shape across at least one of different layers of at least one candidate neural network and across different channels of the at least one candidate neural network.

Clause 7: The method of any of the aforementioned clauses, wherein the at least one learnable linear transform comprises an array of learnable linear transform weights.

Clause 8: The method of any of the aforementioned clauses, wherein selecting a selected candidate neural network comprises selecting a selected neural network from among the plurality of different candidate neural networks for a plurality of different layers of the super-neural network.

Clause 9: The method of any of the aforementioned clauses, wherein the super-neural network and the plurality of different candidate neural networks comprise convolutional neural networks.

Clause 10: The method of any of the aforementioned clauses, wherein selecting a candidate neural network from among the plurality of different candidate neural networks comprises applying a genetic algorithm evolutionary search to select a candidate neural network from among the plurality of different candidate neural networks.

Clause 11: The method of clause 10 or any of the aforementioned clauses, wherein applying the genetic algorithm evolutionary search comprises: selecting the plurality of different candidate neural networks having different topologies from the super-neural network; filtering the plurality of different candidate neural networks from among the selected plurality of candidate neural networks based, at least in part, on one or more performance metrics; applying one or more genetic modifications to the filtered candidate neural networks to provide a plurality of genetic-modified candidate neural networks; and selecting a genetic-modified candidate neural network from among the plurality of genetic-modified candidate neural networks based, at least in part, on the one or more performance metrics as a selected neural network topology.

Clause 12: The method of clause 11 or any of the aforementioned clauses, further comprising iterating the filtering of the candidate neural networks based, at least in part, on the one or more performance metrics and applying one or more genetic modifications to the filtered candidate neural networks repeatedly before selecting the genetic-modified candidate neural network based, at least in part, on the one or more performance metrics as the selected neural network topology.

Clause 13: The method of clause 11 or any of the aforementioned clauses, wherein the one or more genetic modifications comprise a cross-over between and/or among one or more candidate neural networks, or a mutation of one or more candidate neural networks, or a combination thereof.

Clause 14: A machine-readable medium with instructions encoded thereon, the instructions when executed operable to cause a computerized system to: generate a super-neural network embedding a plurality of different candidate neural network topologies; generate at least one learnable transform comprising a plurality of trainable weights, each of the at least one learnable transforms associated with at least one of the plurality of different candidate neural network topologies; train the super-neural network and the at least one learnable transform by adjusting trainable weights of the learnable transform and the at least one of the plurality of different candidate neural network topology embedded in the super-neural network based, at least in part, on training parameters; generate a plurality of different candidate neural networks, each candidate neural network generated from a selected one of the plurality of different candidate neural network topologies, the trained super-neural network, and the at least one trained learnable transform associated with the selected one of the plurality of different candidate neural network topologies by applying the selected one of the plurality of different candidate neural network topologies to the super-neural network to generate a sliced neural network and applying the associated at least one learnable transform to the sliced neural network to generate the candidate neural network; and select a selected candidate neural network from among the plurality of different candidate neural networks.

Clause 15: The machine-readable medium of clause 14, the instructions when executed further operable to cause the computerized system to train the super-neural network and the learnable transform using gradient descent, error backpropagation, or a combination thereof.

Clause 16: The machine-readable medium of any of clauses 14-15, wherein the super-neural network and the plurality of different candidate neural networks comprise convolutional neural networks.

Clause 17: The machine-readable medium of any of clauses 14-16, wherein the selected candidate neural network is to be selected from among the plurality of different candidate neural networks by use of a genetic algorithm evolutionary search to select a candidate convolutional neural network, the genetic algorithm evolutionary search comprising: selection of a plurality of candidate convolutional neural networks having different topologies from the super-neural network; filter of the candidate convolutional neural networks based, at least in part, on one or more performance metrics from among the selected plurality of candidate convolutional neural networks; application of one or more genetic modifications comprising at least one of cross-over between candidate convolutional neural networks and mutation of candidate convolutional neural networks to the filtered candidate convolutional neural networks; and selection of a genetic-modified candidate convolutional neural network based, at least in part, on one or more performance metrics as the selected neural network.

Clause 18: A method of selecting a neural network topology, comprising: selecting a plurality of candidate neural networks having different topologies from a super-neural network; filtering the selected plurality of candidate neural networks based, at least in part, on one or more performance metrics; applying one or more genetic modifications to the filtered plurality of candidate neural networks; and selecting a genetic-modified candidate neural network based, at least in part, on one or more performance metrics as the selected neural network topology.

Clause 19: The method of clause 18, further comprising iterating filtering the candidate neural networks based, at least in part, on one or more performance metrics and applying one or more genetic modifications to the filtered candidate neural networks repeatedly before selecting a genetic modified candidate neural network based, at least in part, on one or more performance metrics as the selected neural network topology

Clause 20: The method of any of clauses 18-19, wherein the one or more genetic modifications comprise cross-over between candidate neural networks, mutation of candidate neural networks, or a combination thereof.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method of selecting a neural network topology, comprising:
generating a super-neural network embedding a plurality of different candidate neural network topologies;
generating at least one learnable transform comprising a plurality of trainable weights, each of the at least one learnable transforms associated with at least one of the plurality of different candidate neural network topologies;
training the super-neural network and the at least one learnable transform by adjusting trainable weights of the learnable transform and the at least one of the plurality of candidate neural network topology embedded in the super-neural network using training data;
generating a plurality of different candidate neural networks, each candidate neural network generated from a selected one of the plurality of different candidate neural network topologies, the trained super-neural network, and the at least one trained learnable transform associated with the selected one of the plurality of different candidate neural network topologies by applying the selected one of the plurality of different candidate neural network topologies to the super-neural network to generate a sliced neural network and applying the associated at least one learnable transform to the sliced neural network to generate the candidate neural network; and
selecting a selected candidate neural network from among the plurality of different candidate neural networks.

2. The method of claim 1, wherein training the super-neural network and the at least one learnable transform comprises training different learnable transforms corresponding to different candidate neural network topologies.

3. The method of claim 1, wherein training the learnable transform comprises using error backpropagation, gradient descent, or a combination thereof to adjust one or more trainable weights of the learnable transform.

4. The method of claim 1, selecting a selected candidate neural network from among the plurality of different candidate neural networks comprises selecting a candidate neural network meeting at least one topology and/or latency constraint.

5. The method of claim 1, the at least one learnable transform comprising multiple learnable transforms corresponding to multiple candidate neural network convolution kernel shapes.

6. The method of claim 5, wherein a same learnable transform is used for a same candidate neural network convolution kernel shape across at least one of different layers of at least one candidate neural network and across different channels of the at least one candidate neural network.

7. The method of claim 1, wherein the at least one learnable linear transform comprises an array of learnable linear transform weights.

8. The method of claim 1, wherein selecting a selected candidate neural network comprises selecting a selected neural network from among the plurality of different candidate neural networks for a plurality of different layers of the super-neural network.

9. The method of claim 1, wherein the super-neural network and the plurality of different candidate neural networks comprise convolutional neural networks.

10. The method of claim 1, wherein selecting a candidate neural network from among the plurality of different candidate neural networks comprises applying a genetic algorithm evolutionary search to select a candidate neural network from among the plurality of different candidate neural networks.

11. The method of claim 10, wherein applying the genetic algorithm evolutionary search comprises:
selecting the plurality of different candidate neural networks having different topologies from the super-neural network;
filtering the plurality of different candidate neural networks from among the selected plurality of candidate neural networks based, at least in part, on one or more performance metrics;
applying one or more genetic modifications to the filtered candidate neural networks to provide a plurality of genetic-modified candidate neural networks; and
selecting a genetic-modified candidate neural network from among the plurality of genetic-modified candidate neural networks based, at least in part, on the one or more performance metrics as a selected neural network topology.

12. The method of claim 11, further comprising iterating the filtering of the candidate neural networks based, at least in part, on the one or more performance metrics and applying one or more genetic modifications to the filtered candidate neural networks repeatedly before selecting the genetic-modified candidate neural network based, at least in part, on the one or more performance metrics as the selected neural network topology.

13. The method of claim 11, wherein the one or more genetic modifications comprise a cross-over between and/or among one or more candidate neural networks, or a mutation of one or more candidate neural networks, or a combination thereof.

14. The method of claim, 1, further comprising a machine-readable medium with one or more instructions encoded thereon that when executed on a computerized system cause the computerized system to carry out the method of claim 1.

15. A method of selecting a neural network topology, comprising:
selecting a selected candidate neural network from among a plurality of candidate neural networks, each candidate neural network generated from a selected one of a plurality of different candidate neural network topologies, a trained super-neural network, and at least one trained learnable transform comprising a plurality of trainable weights and associated with the selected one of the plurality of different candidate neural network topologies, by applying the selected one of the plurality of different candidate neural network topologies to the super-neural network to generate a sliced neural network and applying the associated at least one learnable transform to the sliced neural network to generate the candidate neural network.

16. The method of claim 15, the super-neural network and the learnable transform trained using gradient descent, error backpropagation, or a combination thereof.

17. The method of claim 15, wherein the selected candidate neural network is further selected from among the plurality of different candidate neural networks by use of a genetic algorithm evolutionary search to select a candidate convolutional neural network, the genetic algorithm evolutionary search comprising:
selection of a plurality of candidate convolutional neural networks having different topologies from the super-neural network;
filter of the candidate convolutional neural networks based, at least in part, on one or more performance metrics from among the selected plurality of candidate convolutional neural networks;
application of one or more genetic modifications comprising at least one of cross-over between candidate convolutional neural networks and mutation of candidate convolutional neural networks to the filtered candidate convolutional neural networks; and
selection of a genetic-modified candidate convolutional neural network based, at least in part, on one or more performance metrics as the selected neural network.

18. A method of selecting a neural network topology, comprising:
selecting a plurality of candidate neural networks having different topologies from a super-neural network;
filtering the selected plurality of candidate neural networks based, at least in part, on one or more performance metrics;
applying one or more genetic modifications to the filtered plurality of candidate neural networks; and
selecting a genetic-modified candidate neural network based, at least in part, on one or more performance metrics as the selected neural network topology.

19. The method of claim 18, further comprising iterating filtering the candidate neural networks based, at least in part, on one or more performance metrics and applying one or more genetic modifications to the filtered candidate neural networks repeatedly before selecting a genetic modified candidate neural network based, at least in part, on one or more performance metrics as the selected neural network topology.

20. The method of claim 18, wherein the one or more genetic modifications comprise cross-over between candidate neural networks, mutation of candidate neural networks, or a combination thereof.
